(19) United States
(12) Patent Application Publication
(10) Pub. No.: US 2003/0018823 A1
(43) Pub. Date: Jan. 23, 2003

(54) Network enabled low-cost smart microdevice

(76) Inventors: Roberto Ponticelli, Caracas (VE); Roger Pinate, Caracas (VE); Felix Missel, Caracas (VE)

Correspondence Address: JEFFREY FURR, 253 N. MAIN STREET, JOHNSTOWN, OH, 43031, US

(21) Appl. No.: 09/682,094

(22) Filed: Jul. 18, 2001

(51) Int. Cl. G06F 15/16

(52) U.S. Cl. 709/253

(57) ABSTRACT

On the preferred embodiment, the basic system comprises a communication serial bus 8, which interconnects one or several remote smart micro-units 14, minimal in size and cost, with a master controller unit 2. The remote unit 14 controls and monitors the operation of one or several sensors, actuators or peripherals 12. The resulting network system provides reliability, and easy and low-cost deployment. The network utilizes the Inter-Integrated Circuit communication (IIC) protocol, with one or more masters 2 on one end of an external bus 8, and one or more slave remote units 14 distributed along the bus 8. The peripherals 12 are powered, controlled and connected to the network via the remote unit 14 attached to them. The remote units are configured and operated via the network, receiving commands issued by the master 2.

### BACKGROUND OF INVENTION

1. Field of Invention

This invention relates to electrical control systems and more particularly to a serial transmission system for controlling peripheral electrical devices arranged in a network.

2. Prior Art

Centralized control systems allow a central station to monitor and control the state and operation of the system. The primitive way to reach a solution of this type has involved connecting each sensor or actuator to the control center. This causes the wire assembly and the wiring to be troublesome. System maintenance or replanning becomes very slow and expensive.

A proposed solution to this has very been implemented lately and involves the use of the PLC (Programmable Logic Controller), introducing certain intermediate intelligence between sensors or actuators and the control center. The sensorial devices and actuators (peripheral) are connected to control modules creating groups, and these groups are connected to other modules of higher hierarchy, and so on until the master PLC is reached.

This system provides remarkable ease in the installation phase, and even more in maintenance, but the wiring is still troublesome, and there are still a bundle of wires arriving at the same place. Even in the simplest of systems, the PLC network can become complex enough, in addition to its great expense.

In today's market, other approaches to control communication networks exist, but the relationship between the computational power of the control modules, the ease of installation, and cost is not yet favorable.

Typically, a programmer who must be transported to the place where the module resides must configure control modules manually. This can turn the initial system configuration process very slow and troublesome. If configuration parameters need to be modified, there is the expense of having trained personnel identify the needed modifications and reach the place to perform necessary actions. Further, it is common that device failure causes an entire device network to fail.

Another disadvantage to existing systems is that they do not to provide a dedicated area in the neighborhoods of the peripheral where the control module resides. Furthermore, there is the need for power supply for the module and the peripheral.

With this proposed system, all the mentioned drawbacks encountered in the other systems are solved. Further more, this way is an inexpensive yet simple one to avoid those drawbacks and constraints coming from deploying other systems.

### SUMMARY OF INVENTION

In the preferred embodiment, the present invention comprises a serial communication network to which low cost remote intelligent devices are connected, which are able to monitor and control the operation of sensors and peripheral actuators, and establish a reliable control network with easy implementation and low cost.

### OBJECTS AND ADVANTAGES OF INVENTION

Accordingly, several objects of the present invention are:

to solve the disadvantages of existing control systems and to provide a method and system for low-cost, easily-implementable and reliable control and monitoring networks;

to present a control network architecture in which the wiring of the system is reduced to a minimum;

to present a method and apparatus to establish external long distance communication networks based on the IIC communication protocol, originally conceived for local networks of chips within a same printed circuit board;

to present a control system able to provide control intelligence to peripheral devices that are not network-ready;

to present a control network architecture that allows the inclusion of a new remote device in a simple way, in which the configuration of the new device is done by the system itself and not by an programmer that must be taken to the site where the remote unit resides.

Likewise, several advantages of the present invention are:

the remote units are versatile in their configuration, permitting reuse of same hardware for different applications, and accept connections from peripherals of different characteristics and functions;

the remote units are very small in size, making it easy to conceal them even within the peripheral case, if this allows it, or within the electrical box where the peripheral point of wiring in the electrical installation resides;

great ease of network device configuration through the network itself, without having to configure each device manually or locally;

the power distribution for remote devices and peripherals through the communication bus reduces installation cost without requiring local power sources for remote devices and low power peripheral.

Other objects and advantages of this invention will become apparent from a consideration of the ensuing description and drawings.

### BRIEF DESCRIPTION OF DRAWINGS

FIG. 1 Basic proposed system.

FIG. 2 Bus connection to MASTER side.

FIG. 3 HI-Z Switch and Buffer, MASTER side.

FIG. 4-a Micro Remote Unit connected to a peripheral.

FIG. 4-b Micro Remote Unit connected to an IR Sensor.

FIG. 5 Preferred Embodiment of the Micro Remote Unit.

FIG. 6 Communication flow.

FIG. 7 Address and command decoding.

Reference Numerals

2 Network Master.

4 Local IIC network.

6 Block with the IIC buffer and the HI_Z switch.

8 External IIC bus.

10 Power supply for the Master unit and the external bus.

12 Peripheral.

14 Micro Remote Unit.

16 Bus enabling signal.

18 HI_Z switch.

20 Hi current IIC buffer.

22 Bus Connections.

24 Bus wire.

26 IIC lines Pull-up resistors.

28 MOSFET-N channel, enhancement transistor.

30 Peripheral interconnection.

32 IR sensor.

34 Relay.

### DETAILED DESCRIPTION

### DETAILED DESCRIPTION OF DRAWINGS

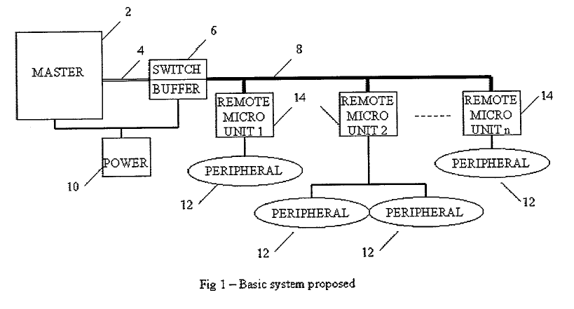

FIG. 1 Basic proposed system.

The preferred embodiment of the present invention comprises a communication bus 8 based on the IIC protocol. An end of bus 8 is connected to a block 6 comprising a high current IIC buffer with a high impedance disconnection circuit. At this point, a local IIC network 4 is connected, and is controlled by at least one master 2. A power supply 10 supplies energy for master 2 and bus 8. Remote devices 14 are connected through bus 8. Peripheral devices 12, such as infrared motion detectors, push button, switches, smoke detectors, proximity reader, RS-232 serial communication devices, etc., are integrated into the network by connecting them to said remote devices.

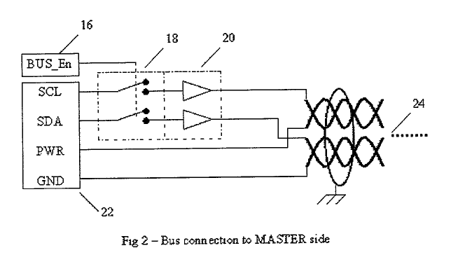

FIG. 2 Bus connection to MASTER side.

By using a buffer IIC 20 it is possible to obtain a long communication bus 8, up to one mile long, although the maximum distance will depend on the communication speed, the wire type and the load connected to the bus 8. A shielded wire 24 with two twisted pairs inside is used. As the length of wire 24 increases and the maximum communication speed is reduced, there exists a high impedance disconnection circuit 18 between buffer 20 in the side of masters, and masters 2 itself. By means of a BUS_En signal, the disconnection circuit may disconnect IIC bus 8 from the master circuit when necessary. Thus, the local IIC network 4 within the side of the masters may contact local devices at speeds greater than allowed in the external long distance bus 8. Connections 22 of bus 8 are clock line SCL (IIC SERIAL CLOCK), data line SDA (IIC SERIAL DATA), supply line PWR, and ground line GND.

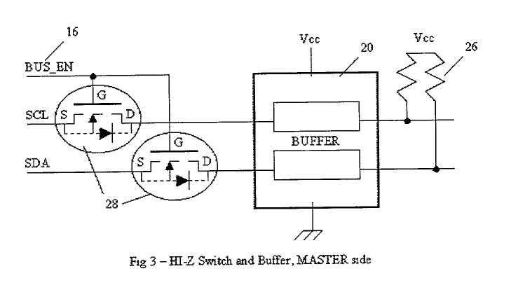

FIG. 3 HI-Z Switch and Buffer, at MASTER side.

A pair of MOSFET transistors 28, channel N, Enhancement, composes the high impedance disconnection circuit 18. Between circuit 18 and bus 8 lies a bi-directional IIC buffer 20.

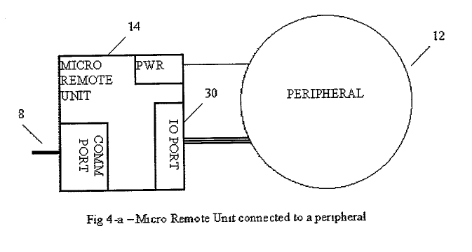

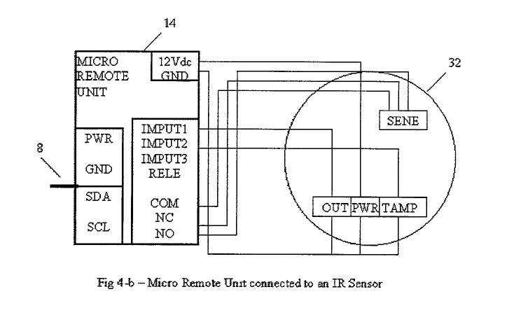

FIG. 4-a Remote Micro Unit connected to a peripheral.

One side of the remote device 14 is connected to the communications bus 8 to allow information exchange with master control 2, and the other side is connected to the peripheral device 12 that is to be controlled. This latter connection is implemented through an I/O port 30 on the remote device. Peripheral device 12 receives power supply from and its functions are controlled by remote device 14.

FIG. 4-b Remote Micro Unit connected to an IR Sensor.

For instance, an infrared movement detector device 32, typically comprising a 12 Vdc positive power input PWR, a ground return, an output OUT composed of two points of a contact that is opened when motion is detected, an output TAMP consisting of another contact that opens when the detector case cover has been removed, and an internal selector SEN for device motion sensitivity.

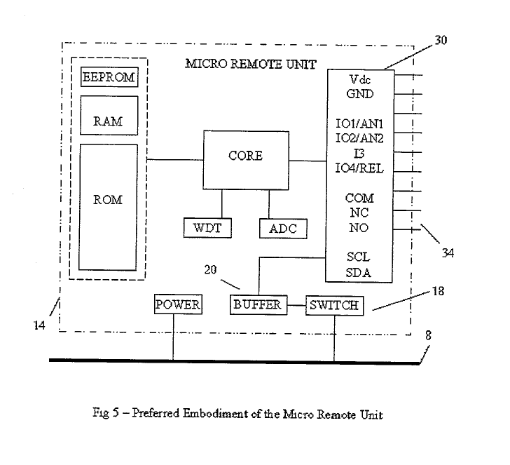

FIG. 5 Remote Micro Unit Preferred Embodiment.

In the preferred embodiment, the remote device 14 consist of a low cost and low size microcontroller system, a RAM memory, a ROM program memory, a non-volatile memory (EEPROM), an IIC communication port with SCL and SDA lines, an I/O port 30 for interconnection with the peripheral device, a relay port with its COM, NC and NO contacts, an ADC converter for analogical voltage readings, a watch-dog timer WDT which guarantees the operation of the device, the POWER conditioning system, and an information processing CORE. To minimize remote device size and cost, a low cost 8-bit microcontroller has been used. Said microcontroller comprises, in a single chip, all said characteristics, such as ROM, RAM, EEPROM, the digital and analogical I/O, CORE, ADC, and WDT. An example is microcontroller PIC12674. Using this 8 pin chip, along with a POWER conditioning circuit, the IIC communication BUFFER 20, the high impedance disconnection circuit 18 and the relay, it is possible to implement remote device 14 within dimensions comparable to those of a matchbox, thus allowing, for instance, to easily hide the remote device 14 within the connection box where the peripheral device is physically installed in the building.

The high impedance disconnection circuit 18 comprised in remote device 14 is used for disconnecting remote device 14 from the communication bus 8 in case of a power failure on the device, while not altering the state of the bus 8 and allowing the rest of the system to operate normally. In this case, the transistor's GATE connection is always connected to the same voltage as the IIC bus pull-up resistors.

The power conditioning circuit has a voltage regulator that regulates the voltage to the level required by the microcontroller and the IIC communication lines.

In this preferred embodiment, there is a port 4 with configurable IO pins. Pins IO1/an1 and IO2/an2 can be individually set to work as digital input or digital output or analog voltage input.

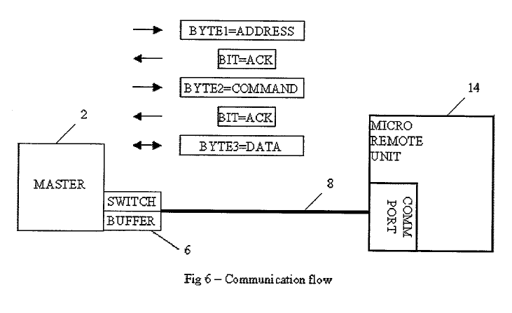

FIG. 6 Communication flow.

Three bytes are transmitted in each communication process. First byte BYTE1 corresponds to the remote device ADDRESS to which the message is directed. Master behaves like MASTER-transmitter and remote device 14 like SLAVE-receiver. Second byte BYTE2 corresponds to the COMMAND that is to be executed by remote device 14. Master 2 behaves like MASTER-transmitter and remote device 14 like SLAVE-receiver. Third byte BYTE3 corresponds to the data byte DATA associated with the command. If DATA is to be used by remote device 14, master 2 behaves as MASTER-transmitter and remote device 14 as SLAVE-receiver. If DATA corresponds to information that master 2 reads in remote device 14, then master 2 behaves like MASTER-receiver and remote device 14 like SLAVE-transmitter. After identifying the direction in first byte BYTE1 and the command in second byte BYTE2, the action corresponding to this command is executed. At the end of the transmission of first byte BYTE1 and second byte BYTE2, verification of receipt at the remote device by means of an acknowledge bit ACK is expected.

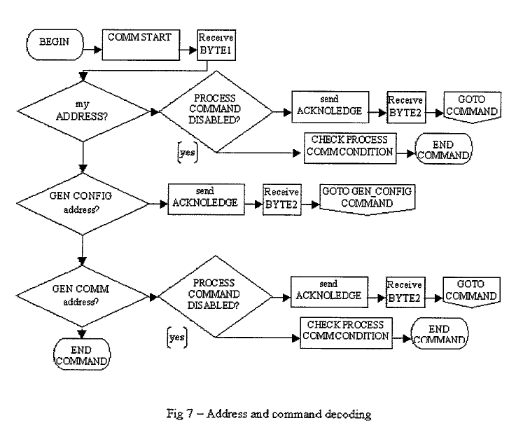

FIG. 7 Address decoding.

Remote device 14 responds to different addresses from bus 8. The received address is compared with the programmed addresses, and the necessary actions for each case are executed. If the received address does not match any of said address, then remote device 14 ignores the remainder of the communication, and waits for the beginning of a new communication cycle.

### OPERATION OF INVENTION

The preferred embodiment of the invention comprises a communication bus 8 based on the IIC protocol. Two lines are used in this serial communication system. An SDA line is dedicated to transmission of data bits, and an SCL line is dedicated to transmission of the clock signal.

Block 6 comprising an IIC high current buffer and a high impedance disconnection circuit is connected to an end of bus 8, which is connected to a IIC local network 4 controlled by a master 2. Power supply 10 provides energy for masters 2 and for bus 8. Bus 8 connects to the remote devices 14, and these connect to the peripheral devices 12 that are to be integrated into a network.

As shown on FIG. 2, the chosen pairs in the twisted pairs, i.e., SCL/PWR in one pair and SDA/GND in the other pair, reduce the coupling between both communications lines. In addition, connecting the shield to ground reduces the level of interference caught by wires 24. If the GND wire and shield are connected to the same point, then the total parasitic capacitance of wires with respect to GND increases, decreasing the bandwidth available in the wire. For this reason, it is better to pair the data line with ground instead of the clock line, since the clock line presents the greatest transmission change frequency.

The selected power to be transmitted through the bus is 12 Vdc, since this voltage is quite common to power electrical peripheral devices like infrared detectors, smoke detectors, vibration detectors, etc.

The communication through IIC bus 8 is done by means of two lines handled by open collector outputs stages. The high level is obtained by means of pull-up resistance 26 connected to the lines, and the low level is obtained driving the line to zero. This allows the occurrence of data collisions without risk of damage at the output stages of the bus drivers. Due to the connection of the transistor 28 as shown in FIG. 3, i.e., with the GATE connected to the same voltage as pull-ups, as soon as a low level occurs at one side of the line, the transistor turns on and pushes the other side of the line to the same low level. When the level is high, the transistor is off allowing both sides of the line to be pulled to the high level by the pull-up resistance 26 which must be present. If GATE voltage is zero, then the transistors will not turn on, thus blocking communication from one side to the other with high impedance, and isolating each side from the other.

Next to the bus disconnection circuit 18 lies the bi-directional IIC buffer 20, which amplifies the communication current towards the long bus 8 side. Buffer 20 can be, for example, a buffer 87b715 that allows a current amplification by a factor of 10.

The high impedance disconnection circuit 18 in remote device 14 is used to disconnect remote device 14 from the communication bus 8 in case of device power failure, while preserving the state of the bus 8 and allowing the rest of the system to operate normally. In this case, the connection GATE of the transistor 28 always connects to the pull-up voltage of the IIC bus. This way, if the power of the remote device fails, or gets disconnected, the high impedance switch 18 isolates the device remote 14 from the network.

In the example of FIG. 4-b, the output contacts of the IR sensor can be connected to GND of remote device 14, and to one input of the remote device, whereas the selection of sensitivity can be made by means of the connection of internal selector SEN to the relay contacts of the remote device 14. By means of configuration commands transmitted by master 2 through network 8, each pin of port I/O 30 of remote device 14 is set as necessary. In this case, two port inputs with pull-up resistance are required for connections to the output switch contacts of the IR detector 32.

In the remote device 14 shown in FIG. 5, RAM memory is used to store variables necessary for device operation. ROM memory stores program instructions that provide communication capacity and control to the remote device 14. EEPROM memory stores critical values of configuration, calibration, operation, etc, that have to be recovered after power disconnection or failure. CORE executes programs stored in ROM, carrying out operations on the registries and variables of RAM and EEPROM, as well as in IO 30 and communication ports.

In the analog voltage input mode, there are three possible combinations, namely, input pin IO1/an1 with reference to 5 Vdc, input pins IO1/an1 and IO2/an2 with reference to 5 Vdc, and finally pins IO1/an1 and IO2/an2 which may be configured as analog inputs, where the voltage conversion at pin IO1/an1 is done with reference to pin IO2/an2. The ADC performs voltage conversion.

Furthermore, the digital voltage input mode permits the use of internal pull-up resistance in the microcontroller, which proves very useful for reading the state of switches connected to these pins. In the digital output mode, the CMOS configuration is exclusively of the push-pull type.

Remote device 14 performs operations on the 10 port 30 and internal variables based on the commands received from the master 2 through bus 8.

The following format comprises an established general rule for the communication process in the preferred embodiment. It uses the STANDARD IIC communication protocol, with 8-bit ADDRESS, master 2 acting as IIC MASTERS, and remote device 14 acting as IIC SLAVE. When a remote device has not been configured for the first time, it contains default address ADDRESS=default. This address cannot be assigned to remote devices under normal operation. If a device with this address is detected in the bus, it is considered a new device in the network and is not configured.

The normal address is used when sending commands to a specific remote device in the bus. It is the normal way of operation. GENERAL CONFIG ADDRESS is a BROADCAST address that places all devices connected to the bus in a wait state by means of a special configuration command. Instead, when the GENERAL COMMAND ADDRESS is used, all devices connected to the bus act as if being addressed with their own address. This address allows BROADCAST of normal commands.

When an address is received, it is first compared with the programmed normal address. If they do not match, then it compares the direction received with the programmed GENERAL CONFIG ADDRESS. If it does not match, it compares with the programmed GENERAL COMMAND ADDRESS.

The communication speed depends on the speed of the clock in the SCL line, dominated by the master. A characteristic of the IIC standard is the possibility of slowing down the communication speed by controlling the SCL line on the SLAVE side of remote devices 14. To achieve this, remote device 14 holds down the SCL line as long as necessary to allow the remote device to do its job before returning the requested information.

This characteristic is useful when a command requests the remote device 14 to perform a task that can take more time to complete than exists between the second ACK bit and the beginning of the transmission of the third byte DATA. Thus, master 2 waits until the remote device finishes its task to receive the BYTE3 with the requested information. In master 2, knowledge of the maximum time delay is important, so that if remote module 14 does not respond within this maximum timeframe, then the current process of communication is aborted and a fresh one is started.

Through the use of commands directed to remote devices 14, control and monitoring actions are executed on peripheral 12, one remote device 14 at a time, or several simultaneously using BROADCAST commands. If performing a measurement in several devices is desired, with phase coherence, a command must be sent to the remote devices 14 by means of BROADCAST. This way, each device takes its reading and stores the resulting value in RAM at a set time, although the reading of each device peripheral 12 information may be done sequentially by master 2.

Conclusion, Ramifications and Scope of Invention

The disclosed system:—Presents a control network architecture in which the wiring of the system is minimized, both in cost and complexity of design, implementation and maintenance;—Presents a long external communication network based on the IIC communication protocol;—Presents a control system that provides control intelligence to peripheral devices that are not network-ready;—Presents a network architecture of control that allows the inclusion of a new remote device in a simple way;—Allows that new device configuration be done by the same system through the network.

Implements remote units that are versatile in configuration, allowing the reuse of the same hardware in different applications and connections to peripheral of different characteristics and functions;—Results in a small implementation size of remote units which allows easy concealment even within the very case of the peripheral, if possible, or within the electrical box at the point of wiring of the peripheral.

Allows the distribution of power for remote devices and peripherals through the communication bus, reducing the installation cost since it does not require local power supplies for remote devices and low power peripherals.

A further embodiment of the proposed system, the bi-directional communication bus can be implemented using different media access, like RS-485, which allows reaching longer distances. To maintain the quality of power transmission through the bus, the type of power source connected to the bus may be changed. Using an AC source diminishes the loss in transmitted power, and only a rectifier and a filter in the remote device are necessary to obtain required DC feeding.

It is possible also to implement a remote device with more than one processor, so that it is possible to divide the tasks between processors. For instance, it is possible have a dedicated processor for bus communication, while another processor can be dedicated to conduct monitoring and control operations on the peripheral one.

While our above description contains many specificities, these should not be construed as limitations to the scope of the invention, but rather as an exemplification of one preferred embodiment thereof. Obviously, modifications and alterations will occur to others upon a reading and understanding of this specification such as extending the characteristics of the remote device by changing the way in which each one of its parts is implemented. The memory of the device can have greater capacity, the processor can be of greater processing speed, can offer greater amount of 10 ports, as well as other facilities incorporated in the same chip or board. The conditioning of power supply can be implemented with a switching regulator, so that the efficiency of the consumed energy is taken to the optimal level, and so on.

The description above is intended, however, to include all such modifications and alterations insofar as they come within the scope of the appended claims or the equivalents thereof.

What is claimed is:

1. A device comprising:
a plurality of processing means connected to a buffer means which is connected to comunication bus which is connected to a plurality of remote devices.

2. The device according to claim 1 wherein the buffer means is a IIC buffer with a high impedance disconnection circuit.

3. The device according to claim 1 wherein a IIC protocal is used.

4. The device according to claim 1 wherein the buffer means is an IIC buffer and the buffer is connected by a high impedance disconnection circuit to the processing means, and which said disconnection circuit will disconnect said IIC buffer based on a BUS_En signal.

5. The device according to claim 1 wherein said remote device is connected to a peripheral device.

6. The device according to claim 1 wherein said remote device is a microcontroller.

7. The device according to claim 1 wherein said remote device is comprised of a microcontroller, RAM memory, ROM memory, a non-volatile memory, an IIC communication port with SCL and SDA lines, an I/O port for interconnection with a peripheral device, a relay port with COM, NC and NO contacts, an ADC converter for analogical voltage readings, a timer WDT, a POWER conditioning system, and an information processing means.

8. The device according to claim 1 wherein the communication bus is connected to the remote device through a high impedance disconnection means.

9. The device according to claim 1 wherein the buffer is a bi-directional IIC buffer which amplifies the signal on the communcation bus.

10. The device according to claim 1 wherein said remoted device will have a default address when added to the communication bus, and said processing means issues a general config address command to a plurality of remote devices through the communication bus, which will put the remote devices into a wait status, and when the processing means issues a general command address to all the remote devices on the communication bus the remote devices will act as being addressed with their address.

11. The device according to claim 1 wherein said the high impedance switch makes it possible to use of two networks of different speeds connected to the same master.

12. A process for connecting a serial communcation network to remote devices comprising the steps of:
Connecting a plurality of processing means to a buffer means, connecting the buffer means to a comunication bus and connecting the communication bus to a plurality of remote devices.

13. The process according to claim 11 wherein the buffer means is an IIC buffer with a high impedance disconnection circuit.

14. The process according to claim 11 wherein a IIC protocal is used.

15. The process according to claim 11 wherein the buffer means is an IIC buffer and includes connecting the buffer with a high impedance disconnection circuit to the processing means, and having said disconnection circuit disconnecting said IIC buffer based on a BUS_En signal.

16. The process according to claim 11 which includes the step of connecting said remote device is connected to a peripheral device.

17. The process according to claim 11 wherein said remote device is a microcontroller.

18. The process according to claim 11 wherein said remote device is comprised of a microcontroller, RAM memory, ROM memory, a non-volatile memory, an IIC communication port with SCL and SDA lines, an I/O port for interconnection with a peripheral device, a relay port with COM, NC and NO contacts, an ADC converter for analogical voltage readings, a timer WDT, a POWER conditioning system, and an information processing means.

19. The process according to claim 11 which includes the step of connecting the communication bus to the remote device through a high impedance disconnection.

20. The process according to claim 11 which adds the step of amplifying the signal on the communciation bus using a bidirectional IIC buffer.

21. The process according to claim 11 which includes the steps of having a default address for the remoted device, having the processing means issue a general config address command to a plurality of remote devices through the communication bus, putting the remote devices into a wait status, and having the processing unit issue a general command address all the remote devices and having the remote devices acting as being addressed with their address.

22. The device according to claim 11 wherein said the high impedance switch makes it possible to use of two networks of different speeds connected to the same master.
